(19) United States
(12) Patent Application Publication
(10) Pub. No.: US 2006/0262336 A1
(43) Pub. Date: Nov. 23, 2006

(54) Manual annotation document reformation

(75) Inventors: Venkatachalam Ramasubramani Venkatachalam, Bangalore (IN); Burton Lee Levin, Lake Oswego, OR (US)

Correspondence Address: Gerald W. Maliszewski, P.O. Box 270829, San Diego, CA, 92198-2829, US

(73) Assignee: Sharp Laboratories of America, Inc.

(21) Appl. No.: 11/135,225

(22) Filed: May 23, 2005

(51) Int. Cl. G06F 3/12

(52) U.S. Cl. 358/1.13

(57) ABSTRACT

A printer driver and a method are provided for reformatting a document for manual annotations in a printer driver software program. The method includes: accepting an electronically formatted document page setup for a printed medium sheet; selecting a manual annotation option; in response to the selected option, editing the relationship between the document page and the printed medium sheet; and, creating a manual annotation region on the sheet adjacent the document page. For example, the manual annotation region can be created in a region to the right of the page. However in other aspects, the annotation can be to the left of the page, above the page, below the page, or between image objects (i.e., between lines of text).

### BACKGROUND OF THE INVENTION

1. Field of the Invention

This invention generally relates to digital document processing and, more particularly, to a printer driver software program that modifies the relationship between the document page and the printer media sheet, so as to create a manual annotation region.

2. Description of the Related Art

It is frequently desirable to add comments while reading a printed document, such as when a person is participating as a member of an audience during a presentation of the document. Students in class, for example, may want to annotate a lecturer's notes while the lecturer is presenting the information.

Conventionally, a user has been forced to use the margin space and space in-between lines for notes. It is usually true that there is very little space, and the writing becomes cramped and sometimes illegible. Alternately, a separate paper can be used for adding notes or comments. However, it is difficult to cross-reference the notes to the actual passages on the original document.

If the user has access to an electronic copy of the document, they may choose to reformat the document to create spaces where notes can be added. However, some documents are read-only and cannot be changed. Some documents are difficult to reformat, for example, documents with multiple columns of test, or documents with combinations of text and images. Further, it is awkward and difficult to maintain the page numbering between an original and a reformatted document. For example, a lecturer's references may be inconsistent with the page numbering on the note taker's hard copy and, therefore, harder for the note taker to keep track of references. In other circumstances, the user may not have the application that created the original document but only a printable image, such as a TIFF file. In this case, it is impossible to reformat the document in the application. Changing the format in most applications is a labor-intensive task, as there is a “trial and error” effort required to make the document look satisfactory.

Some applications, such as PowerPoint for example, recognize the need for reformatting a document for the purposes of annotation. However, only a single rigid format option is permitted. Further, this reformation must be performed in the application, and so is subject to all the above-mentioned in-the-application reformatting problems. Other applications, such as Internet Explorer, don't permit the users to make any modifications to the content.

It would be advantageous if a document could be easily modified at the printer driver to create annotation regions.

### SUMMARY OF THE INVENTION

The present invention describes a printer driver software module that permits a user to take a document, prepared by an application with a predetermined relationship between document page and the printed medium sheet setup, and modify this relationship to create regions that can be used for manual annotations. This feature is useful for lectures or training sessions, for users who want to add a detailed description to a document, and in meetings and discussions.

Accordingly, a method is provided for reformatting a document for manual annotations in a printer driver software program. The method comprises: accepting an electronically formatted document page setup for a printed medium sheet; selecting a manual annotation option; in response to the selected option, editing the relationship between the document page and the printed medium sheet; and, creating a manual annotation region on the sheet adjacent the document page. For example, the manual annotation region can be created in a region to the right of the page. However in other aspects, the annotation can be to the left of the page, above the page, below the page, or between image objects (i.e., between lines of text).

Generally, the electronically formatted document page has an initial proportional relationship between image object size, page width, page height, and spacing between image objects. In one aspect, the relationship between the document page and the printed medium sheet is edited while maintaining the page proportional relationships.

For example, the document page may initially be setup for printing on a first printed medium sheet size. In response to selecting a sheet extension manual annotation option, the first sheet size is changed to a second, larger sheet size. More specifically, the document page may initially be setup for printing on a first printed medium sheet size in a portrait orientation. In response to selecting a rotated sheet extension manual annotation option, the relationship between the document page and the printed medium sheet is edited by changing from a first sheet size to a second, larger sheet size, and changing the orientation from portrait to landscape.

Alternately, the relationship between the document page and the printed medium sheet may be edited by scaling the document page. For example, the document page may initially be setup for printing on a first printed medium sheet size in a first orientation. In response to selecting a scaled manual annotation option, the relationship between the document page and the printed medium sheet is edited by maintaining the first printed medium sheet size and orientation, while reducing the page size.

Other aspects of the method further comprise formatting the manual annotation region. For example, for the user's convenience in taking notes, the manual annotation region may be formatted to create underlines or a border.

Additional details of the above-described method and a printer driver with manual annotation reformatting capabilities are provided below.

### BRIEF DESCRIPTION OF THE DRAWINGS

FIG. 1 is a diagram depicting a conventional printing operation using a raw spool file (prior art).

FIG. 2 is a diagram depicting a spooler subsystem (prior art).

FIGS. 3 and 4 are diagrams illustrating Windows EMF printing operations (prior art).

FIG. 5 is a diagram depicting Microsoft Windows NT and 2000 printing operations (prior art).

FIG. 6 is a diagram depicting a Windows 2000 print process (prior art).

FIG. 7 is a schematic block diagram depicting a printer driver with manual annotation reformatting capabilities.

FIG. 8 a diagram depicting the relationship between a document page and a printed medium sheet.

FIG. 9 is a diagram depicting a variety of annotation region options.

FIG. 10 is a first example of a reformatting process that maintains the page proportional relationships.

FIG. 11 is a second example of a reformatting process that maintains the page proportional relationships.

FIG. 12 is a third example of a reformatting process that maintains the page proportional relationships.

FIG. 13 is a first example of a reformatting process that rescales the document page.

FIG. 14 is a second example of a reformatting process that rescales the document page

FIG. 15 is a third example of a reformatting process that rescales the document page.

FIG. 16 is a drawing depicting annotation region formatting options.

FIG. 17A is a diagram depicting a process that creates an annotation region by increasing the printed medium sheet size.

FIG. 17B is a drawing depicted the larger sheets sizes of FIG. 17A, with formatted annotation regions.

FIG. 18 is a drawing depicting a scaled 2UP annotation region formatting option.

FIG. 19 is a depiction of an exemplary layout designer user interface.

FIG. 20 is a flowchart illustrating a method for reformatting a document for manual annotations in a printer driver software program.

### DETAILED DESCRIPTION

Many computing device platforms and printing systems are available today and embodiments of the present invention may be implemented with many of these systems. However, due to the prevalence of the Microsoft Windows® operating system family, aspects used in conjunction with Windows® systems are typically used to illustrate the invention. Accordingly, details of Microsoft Windows® printing processes are explained below.

Microsoft Windows® operating systems typically employ two file types in the printing process. These file types are Enhanced Metafile (EMF) and raw format (raw) files. Raw format files are device dependent files, which are destined and formatted for a specific device. An example of a raw file is an encapsulated Postscript (PS) file that is formatted for interpretation by a Postscript printer. EMF files are device independent files that contain graphic device interface (GDI) function calls that reproduce an application's graphic elements on a printer. EMF files are used to quickly record a printed document and return system control to a user. After control is returned to the user, the function calls stored in the EMF file may be accessed and sent to the printer in the background.

Files may be recorded for later play back by using a spool file that is written and later despooled to a printing device. Spool files may be used for EMF and raw files. However, a print job may also be written directly to a printing device without using a spool file. Some typical printing process scenarios using raw spool files and EMF spool files are described below to introduce the components, elements and relationships of these processes and how they relate to embodiments of the present invention. These scenarios are derived from information contained in the Microsoft Windows 95® Driver Development Kit (DDK) documentation, the Microsoft Windows 2000® DDK documentation and the Microsoft Windows NT® DDK documentation.

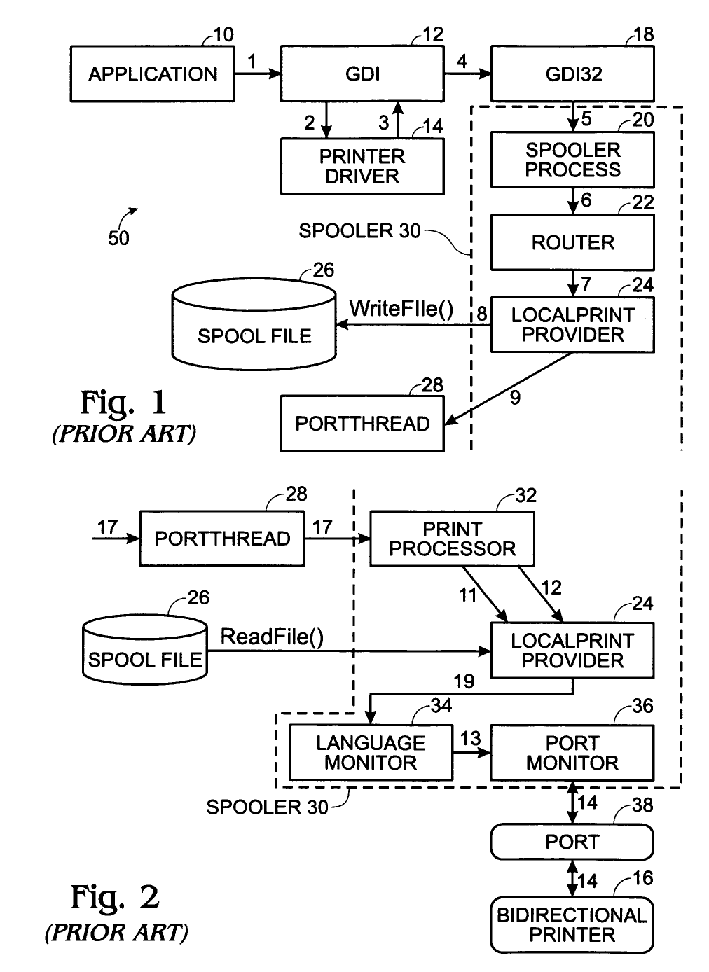

FIG. 1 is a diagram depicting a conventional printing operation using a raw spool file (prior art). Many of the above-mentioned components may be enabled as elements in a computer system 50. The computer system 50 may comprise any type of computing device, including a personal computer, workstation, personal digital assistant, or the like. The computer system 50 typically includes an operating system (not shown). The computer system 50 may run several applications. A single application, application 10 is shown. Examples of applications include word processors, spreadsheets, communication software, and presentation software. Typically, a user of the computer system may utilize application 10 to generate one or more documents. In some aspects, the computer system 50 may further comprise computer network components including other computing devices, servers, routers, hubs, switches and output devices such as displays, printers, plotters, CD writers, tape drives and other devices.

The computer system 50 may be connected to an output device such as a printer (not shown). The output device may be any type of output device that is capable of forming an image and that can be used in combination with the computer system 50. The printer may be used to print one or more documents created by the application 10.

As explained in more detail below, the computer system 50 may comprise an output system or print system for converting an application's output to a format compatible with an output device. An output system or print system may comprise a printer driver, print processor, spooler, print provider, as well as other print system components as described above in relation to Microsoft operating systems. These print system components are software that enable the application 10 to communicate with a printer. When the application 10 needs to print a document, it sends print data to the print system. Print data is data describing the document to be printed. Typically, the print data is a series of commands (e.g., draw a circle, draw a line of text in a particular font, etc.). The printer system accepts the print data from the application 10 and then creates printer ready data. The printer ready data is print data translated into a format that a printer can understand. The format of the printer ready data may depend on the capabilities of the printer. For many low-end printers such as inkjets, the printer ready data is pixel data, i.e., data that may be used to print pixels on a piece of paper. More and more printers are capable of translating images presented in a variety of Printer Description Languages (PDLs), such as PCL (many versions) and PostScript.

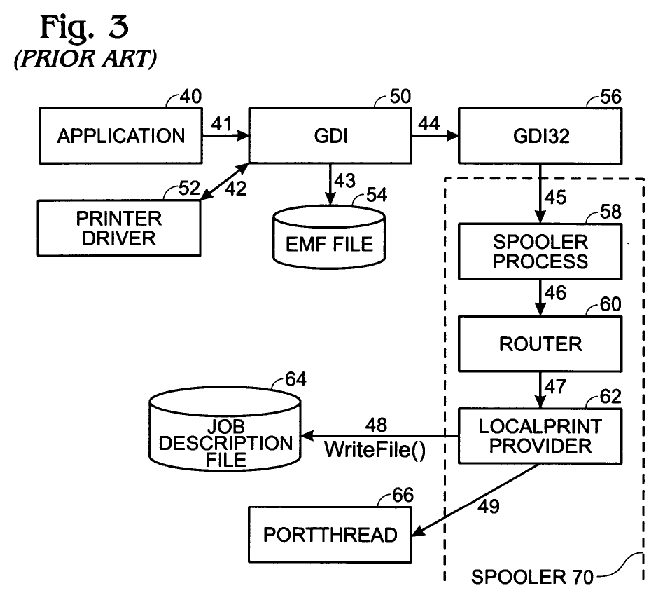

An application 10 initiates a print request 1 by calling a graphic device interface (GDI) 12. Application 10 may be a word processor, spreadsheet, browser, database program, or some other program that runs on the underlying operating system. Typically, application 10 will create a device context (DC) and draw an object (i.e., a circle, a line, etc.) to the DC. The application 10 will then call the GDI with a print request directed to a particular printer 16 (FIG. 2) using that DC.

The GDI 12 will call the printer driver 14 associated with the particular printer 16 and request 2 instructions on how to render the object on that particular printer 16. The printer driver 14 will return 3 the instructions on how to render the object on the printer 16. In Windows 95®, used in this printing process example, the printer driver 14 is written in 16-bit code and communicates with a 16-bit GDI 12. This GDI will then pass the print request to a 32-bit GDI (GDI32) 18 to handle the 32-bit Windows 95® spooler process. GDI32 makes an interprocess call 5 to the spooler process 20.

Spooler process 20 calls 6 the router 22 to route the print job to printer 16. In this example, illustrated in FIGS. 1-2, the router 22 sends the print job to a local print provider 24. In other scenarios, the router 22 may send print jobs to a network printer through a network print provider (not shown). When the default Windows 95® spooler is used, network print jobs are spooled and despooled on the client machine just as local print jobs. The network print server is contacted only during despooling. Windows NT/2000® client machines handle print jobs to network print servers differently, these machines use remote procedure calls (RPCs) to call the necessary printing application program interfaces (APIs) on the print server. In these NT/2000 scenarios, the print jobs do not show up on the local spooler queue. Rather, spooling and despooling are handled by the print spooler on the print server. This RPC method can be used in conjunction with Windows 95® spoolers also. Print jobs to locally connected printers or locally queued to (e.g., LPR) to network printers are handled similarly to Windows 95, 98 local print jobs.

In this local printing scenario, the router 22 calls the local print provider 24 with the print job. Local print provider 24 writes or “spools” 8 a raw spool file 26 to disk for later access. This is done to avoid waiting for the printer to complete the job before control is returned to the application. These steps from initiating the print request 1 to writing to spool file 26 may be repeated many times. Data may be appended to spool file 26 until an application signals that the print job is complete. The job completion may be signaled with an EndDoc function. Local print provider 24 also starts 9 a background thread 28 that will determine the best time to start playing back or “despooling” the spool file 26 to the printer 16.

FIG. 2 is a diagram depicting a spooler subsystem (prior art). Thread 28 monitors spooler subsystem resources to determine a good time to playback spool file 26. When thread 28 determines that playback should commence, a StartDoc function call 17 is sent to print processor 32 to start a new print processor thread 11. Print processor thread 11 invokes the local print provider 24 with a ReadPrinter function call to read part of the spool file 26. A print processor thread 19 also uses the local print provider 24 to invoke the language monitor 34 with a WritePrinter function call to send data through the physical port 38 connected with the bidirectional printer 16 specified previously.

For raw spool files, the default print processor 32 simply passes data through, without changing or interpreting any of the information. A language monitor 34 is used in this example because the destination printer 16 is a bidirectional printer. When non-bidirectional printers are used, a port monitor 36 is invoked instead of the language monitor 34. A language monitor 34 and port monitor 36 may be separate components or may be integrated into one monitor.

Language monitor 34 calls 13 a port monitor 36 to send print job data to the printer 16. The port monitor 36 then sends 15 the raw data through the physical port 38 to the printer 16. This process of reading from a spool file 26 and forwarding data to the printer 16 may be repeated several times to complete a print job. This is typically repeated until an end-of-file is reached or the job is cancelled. The playback thread 19 is terminated at that point. The combination of spooler process, router, local print provider, print processor, language monitor, and port monitor may be referred to collectively as a “spooler” 30.

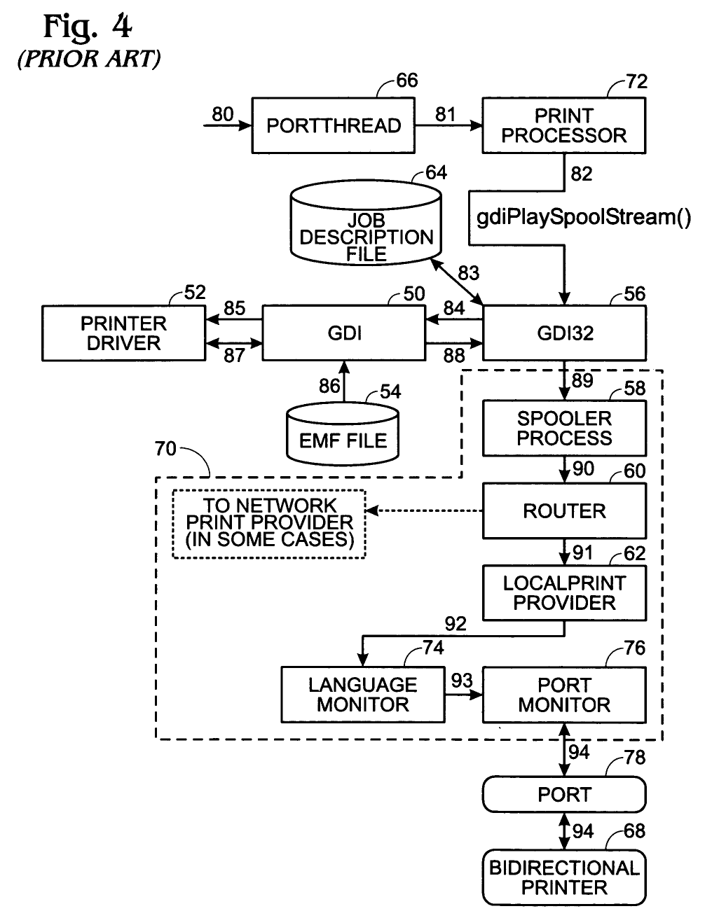

FIGS. 3 and 4 are diagrams illustrating Windows EMF printing operations (prior art). When Windows Enhanced Metafile (EMF) format files are used in the printing process of Windows 9.x systems, process components interact differently than with raw files. An example printing process, shown in FIGS. 3 and 4 illustrates the printing process using EMF files. This process typically commences when an application 40 creates a printer DC and draws an object to the DC (not shown). The application 40 then calls 41 GDI 50 with an EMF spooling request for a designated printer 68. GDI 50 queries 42 the printer driver 52 associated with the designated printer 68 to determine whether the driver 52 supports EMF spooling. If the driver 52 supports EMF spooling, GDI 50 changes the printer DC to an EMF DC and writes 43 the instructions for rendering the object to the EMF DC 54 (creates EMF files). GDI 50 then passes 44 the print request to the 32-bit GDI (GDI32) 56 because, in this example the Windows 95® spooler process is 32-bit code. GDI 32 subsequently makes an interprocess call 45 to the spooler subsystem 70 with a description of the print job.

The spooler process 58 (SPOOL32.EXE), in the spooler system 70, calls the router 60 to pass the print job description to the print provider 62 that can reach the designated printer 68. In this example, a local print provider 62 is used, but a network print provider may also be used. When the default Windows 95® spooler is used, network print jobs are spooled and despooled on the client machine just as local print jobs. The network print server is contacted only during despooling. Windows NT/2000® client machines handle print jobs to network print servers differently, these machines use remote procedure calls (RPCs) to call the necessary printing application program interfaces (APIs) on the print server. In these NT/2000 scenarios, the print jobs do not show up on the local spooler queue. Rather, spooling and despooling are handled by the print spooler on the print server. This RPC method can be used in conjunction with Windows 95® spoolers also.

When the router 60 has called the print provider 62, the local print provider 62 creates 48 a job description file 64 and adds 48 a record to the job description file 64 each time it is called for the job until all the EMF page files have been spooled and each EMF file name and location is recorded in the job description file 64. When information about the last EMF file in the print job has been recorded, the local print provider 62 will call the spooler process 58 with an EndDoc function call. This signals the spooler process 58 that the complete job is spooled and ready for despooling. For multi-page jobs, these steps from initial spooling request 41 to job description file recording 48 are repeated for each page of a job.

When EMF file spooling is complete, the spooler process 58 sets a ReadyToPrint attribute on the print job and initiates an event 49 that signals to the port thread 66 that a job is available for printing. Port thread 66 responds to this event by determining the best time to start the despooling process and, at that time, loads 81 the print processor 72, as shown in FIG. 4. The print processor 72 will determine that the file format is EMF and call GDI32 56 with a Windows 95® function call 82.

GDI32 then invokes a gdiPlaySpoolStream function to read 83 from the job description file 64, which provides a fully qualified path to an EMF spool file 54. Through the job description file 64, which comprises a list of path names to EMF files, GDI32 knows about all the pages in the print job. The GDI32 gdiPlaySpoolStream function also calls GDI 50, using a thunk (a call across platform code) built into GDI32, with the path to the EMF spool file to render the page. GDI 50 only knows about one page in the print job at a time.

GDI 50 calls the printer driver 52 associated with the designated printer 68 chosen in application 40 and obtains a DC for the printer 68. GDI 50 then reads page-rendering instructions from the spooled EMF file 54 and passes 85 them one at a time to the printer driver 52 which uses as many instructions as are necessary to render the first part of the page. When the 16-bit printer driver 52 renders a part of the page, it passes 87 the printer-specific raw page data back to the GDI 50 which, in turn, passes 88 the raw data to GDI32 56. GDI32 56 then passes 89 the raw data to the spooler process 58 which then follows the same procedures it would for a raw format files as explained above.

Spooler process 58 calls 90 the router 60 to route the print job to printer 68. In this example, illustrated in FIGS. 3 and 4, the router 60 sends the print job to a local print provider 62. In other scenarios, the router 60 may send print jobs to a network printer through a network print provider (not shown). In this local printing scenario, the router 60 calls the local print provider 62 with the print job. Local print provider 62 invokes the language monitor 74 with a WritePrinter function call to send data through the physical port 78 connected with the bidirectional printer 68 specified previously.

A language monitor 74 is used in this example because the destination printer 68 is a bidirectional printer. When non-bidirectional printers are used a port monitor 76 would be invoked instead of the language monitor 74. A language monitor 74 and port monitor 76 may be separate components or may be integrated into one monitor. Language monitor 74 calls 93 a port monitor 76 to send print job data to the printer 68. The port monitor 76 then sends 94 the raw data through the physical port 78 to the printer 68.

Parts of EMF pages are processed in this manner and printed until an entire page is printed. GDI32 56 then gets the path to the EMF spool file for the next page and calls GDI 50 to use the instructions in that EMF file to render the next page of the print job. The print job is finished when all the paths to EMF spool files are used up.

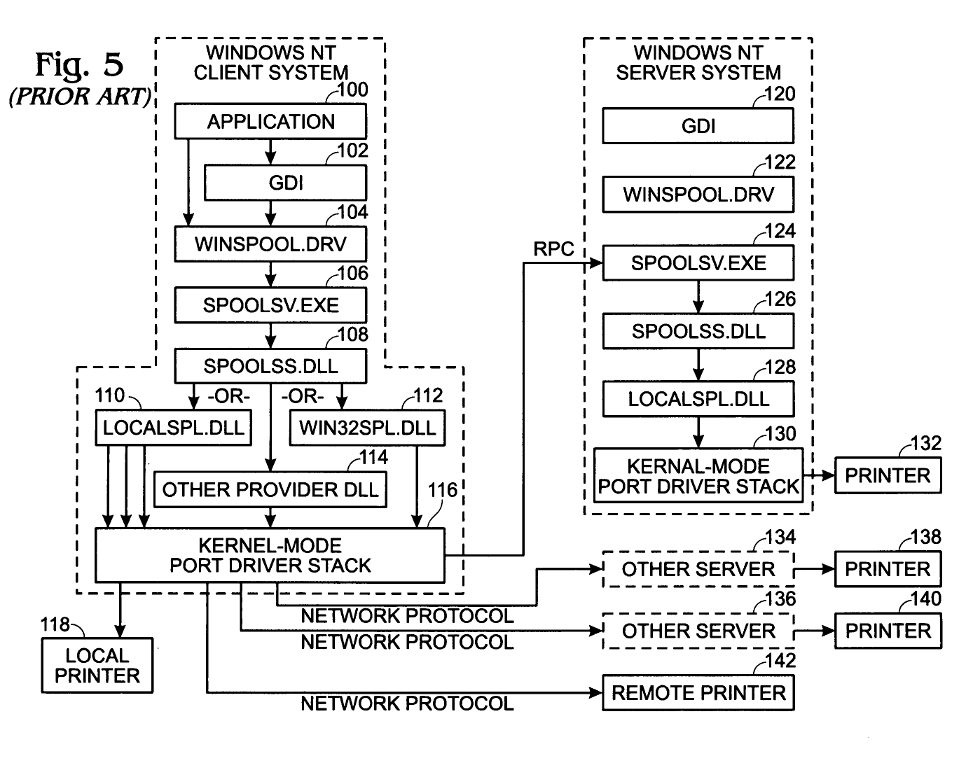

FIG. 5 is a diagram depicting Microsoft Windows NT and 2000 printing operations (prior art). Other versions of the Microsoft Windows operating systems, such as Windows NT and 2000 may use different printing processes. These processes may be used to print data to local, network, and remote printers either directly or through a network print server. EMF data may also be processed differently. For example, in Windows NT and 2000, the entire EMF data for all pages is passed to GdiPlayEMF( ) in one pass, rather than one page at a time. If the EMF data is to be queued on a print server, the EMF data is passed directly to the print server without rendering on the client. A mirror copy of the driver on the server renders the EMF data instead.

Typically, a user will employ an application 100 to create a print job by calling GDI 102 functions. The GDI 102 and/or application 100 will then call Winspool.drv 104, which is a client interface into the spooler. This client interface, Winspool.drv 104, exports the functions that make up the spooler's Win32® API and provides RPC stubs for accessing the server. The print job is then forwarded to the spooler's API server, Spoolsv.exe 106, which can be implemented as a Windows 2000 service that is started when the operating system is started. This API server module exports an RPC interface to the server side of the spooler's Win32® API. This module implements some API functions, but most function calls are passed to a print provider by means of the router, spoolss.dll 108.

The router 108 determines which print provider to call, based on a printer name or handle supplied with each function call, and passes the function call to the correct provider 110, 112 or 114. If the selected printer is managed by the client system, the print job is handled by the local print provider, localspl.dll 110. Printers managed by the local print provider 110 do not have to be physically local to the client, they may also be directly connected to network cards without using a server. When these printers are used, the print job is passed to the kernel-mode port driver stack 116 and on to the printer 118.

When printers located on a Windows NT/ Windows 2000 server are selected, the router 108 directs the print job to the network print provider, Win32spl.dll 112. This network provider uses RPC to redirect calls from the client's router to the network server's spoolsv.exe processl24, which forwards the print job to the network server's router 126. Because the network printer is local to the print server system, the network server router 126 routes the job to the server's local print provider 128. The job is then directed to the server's kernel-mode port driver stack 130 and out to the selected network printer 132.

Remote printers may also be used with these systems. When a remote printer is selected, the client router 108 may direct the print job to the local print provider 110, which will forward the job to the kernel-mode port driver stack 116 and on to the remote printer 142 using a network protocol. When the local print provider 110 accesses a remote printer 142, the provider 110 uses a port monitor that can use network protocols recognized by the remote printer or its server.

Printers managed by non-Windows NT/2000 servers (e.g., Novell servers) may also be accessed through this print system. This may be achieved by using a local print provider 110 that directs the print job to the kernel-mode port driver stack 116 and on to the printer's server 136 using a type of network protocol. The server 136 then directs the job to the destination printer 140. This may also be achieved using a customized print provider 114 which sends the job to the kernel-mode port driver stack 116 which uses a network protocol to send the job on to the printer's server 134, which then directs the job to the destination printer 138.

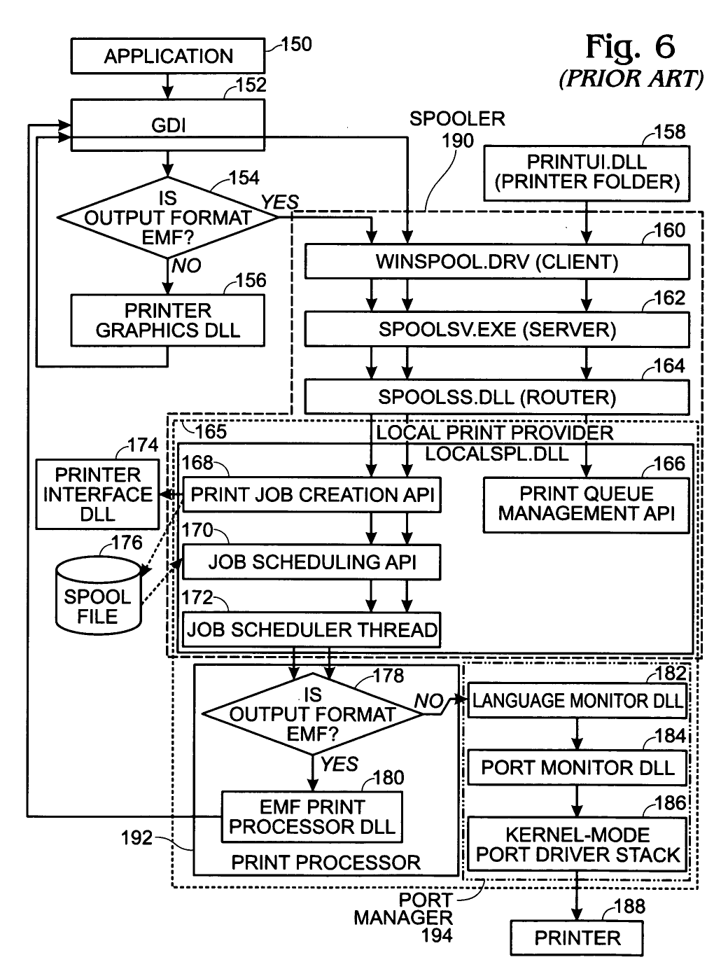

FIG. 6 is a diagram depicting a Windows 2000 print process (prior art). In this process, an application 150 is used to create a print job with the Graphics Device Interface (GDI) 152. When the print job's initial output file is in raw format 154, the printer driver's printer graphics DLL 156 works in conjunction with the GDI 152 to create a print job that is sent to the client interface 160 of the spooler. Client interface 160 sends the job to the API server 162, which forwards the job to the router 164. In this example, the router 164 sends the job to the local print provider 165 as it is a local print job.

Within the local print provider 165, a print job creation API 168 is invoked. This API 168 accesses the printer driver's printer interface DLL 174 and creates a job spool file 176. The job creation API 168 also forwards job information to the job scheduling API 170, which initiates a job scheduler thread 172.

At this point, the file format is checked 178. If the initial job file is in a raw format already, the job is sent to the language monitor DLL 182 and on to the port monitor 184, which sends the job to the kernel-mode port driver stack 186. Port driver stack 186 sends the job to the selected printer 188 for final printing.

When an application 150 creates a print job with GDI 152 in EMF format, the job is sent 154 to a client spooler interface 160. Client interface 160 sends the job to the API server 162, which forwards the job to the router 164. Again, in this example, the router 164 sends the job to the local print provider 165 because the print job is local.

Within the local print provider 165, a print job creation API 168 is invoked. This API 168 accesses the printer driver's printer interface DLL 174 and creates a job spool file 176. The job creation API 168 also forwards job information to the job scheduling API 170, which initiates a job scheduler thread 172.

At this point, the file format is checked 178. If the initial job file is in EMF format, the job is sent to the print processor DLL 180, which directs the job back to GDI 152 for conversion to raw format with the help of printer interface DLL 174. The converted job is then sent back through the spooler client interface 160, API server 162, and router 164 to the print provider 165. In the local print provider, the job is processed by the print job creation API 168, job scheduling API 170, and job scheduler thread 172. Because the job is now in raw format, the job is sent to the language monitor DLL 182 and on to the port monitor DLL 184 and kernel-mode port driver stack 186 before arriving at the destination printer 188.

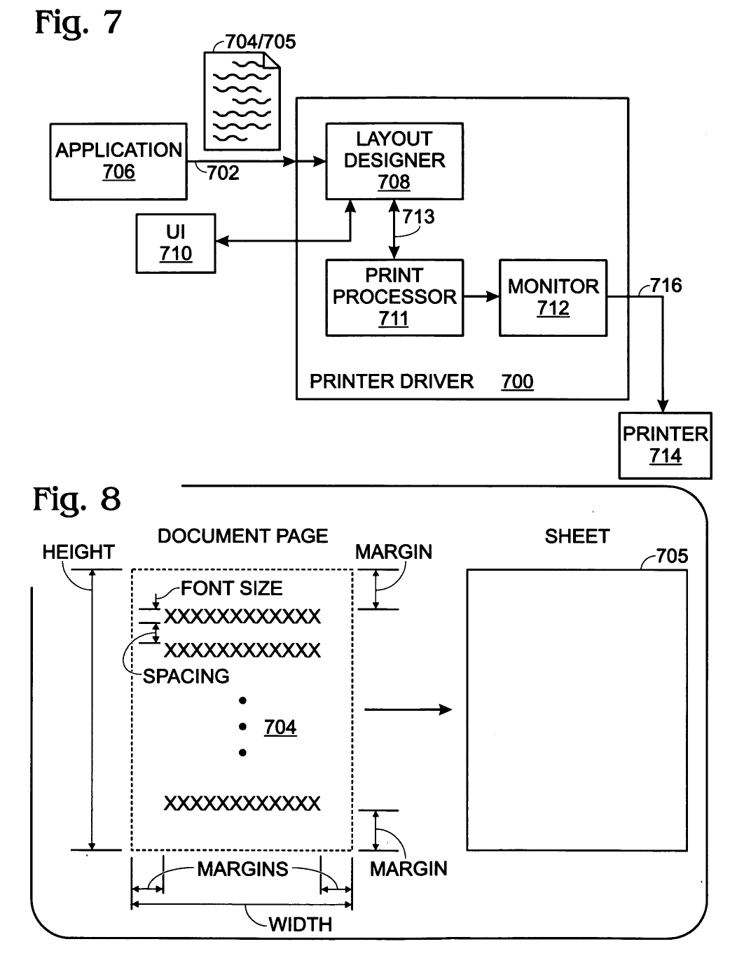

FIG. 7 is a schematic block diagram depicting a printer driver with manual annotation reformatting capabilities. The driver 700 comprises an input on line 702 to accept an electronically formatted document page 704, from a client application 706, setup for a particular printed medium sheet 705. The application 706 may be a word processing application as an example. However, the driver 700 is not limited to use with any particular type of application. The document can also be a web page, graphics file, spreadsheet, database record, composite document ASCII, text, or graphics to name a few examples. Generally as mentioned above, the document page 704 may be in a raw or an EMF type of format. The printed medium sheet, for example, may be 8½ by 11-inch paper.

A layout designer 708 has a user interface (UI) 710 for accepting a manual annotation option. For example, the UI 710 may present the options to a user in the form of a graphical interface menu with selected choices. The layout designer 708 accepts the document page 704 and edits the relationship between the document page and the printed medium sheet, in response to the selected option. The process of editing creates a manual annotation region on the sheet adjacent the document page.

For convenience, a print processor 711 is shown that performs the conventional print job rendering functions of the printer driver 700. Although the drawing implies that the print processor 711 performs the rendering tasks subsequent to manual annotation region reformatting, the dual-facing arrow (713) connecting printer processor 711 and layout designer 708 is intended to show that reformatting occurs simultaneously with the rendering process. Note, the reformatting can take place concurrently with the creation of an EMF (or other PDL) file. For example, the scaling and orientation can be done by the print driver at the same time that the image is being converted to a PDL or raster image.

A monitor 712 supplies the document page with annotation region to a printer 714 on line 716. Depending on printer type, the monitor 712 can be either a port monitor or language monitor.

FIG. 8 a diagram depicting the relationship between a document page and a printed medium sheet. When working in an application, one of the initial choices made by a user concerns printed medium sheet size and orientation. For example in Microsoft Word, page setup permits the user to select paper size, and either a portrait or landscape orientation. Typically, the user accepts the default selections, which may be 8½ by 11-inch paper and a portrait orientation. Once the printed medium sheet is selected, the user forms the content within the boundaries of the sheet. For example, if the user is creating a text document, the document page is defined by such elements as margins, font size, and line spacing. The page height and width are limited by the sheet size, but can be made smaller than the sheet using margins. If the user selects an alternate sheet size 705 or orientation after a document page 704 has been created, the document page 704 will necessarily change. For example, if a sheet orientation is changed from portrait to landscape, the lines of text are likely to become longer (as both the page and sheet are wider) and fewer in number. Generally then, once a document is finished (i.e., saved or sent to a printer driver), there is a relationship between the document page 704 and the printed media sheet 705. Alternately stated in the terminology of Word, there is a relationship between the document page and the page setup.

Returning to FIG. 7, the printer driver 700 accepts a document page 704 having a proportional relationship between image object size, page width, page height, margins, and spacing between image objects. The term “image objects” has been chosen to describe the document page content elements that might be used in a number of different applications. As used herein, “image objects” are intended to describe groupings of text, such as a line of text, images, or graphics. In one aspect, the layout designer 708 edits the relationship between the document page and the printed medium sheet, while maintaining the page proportional relationships.

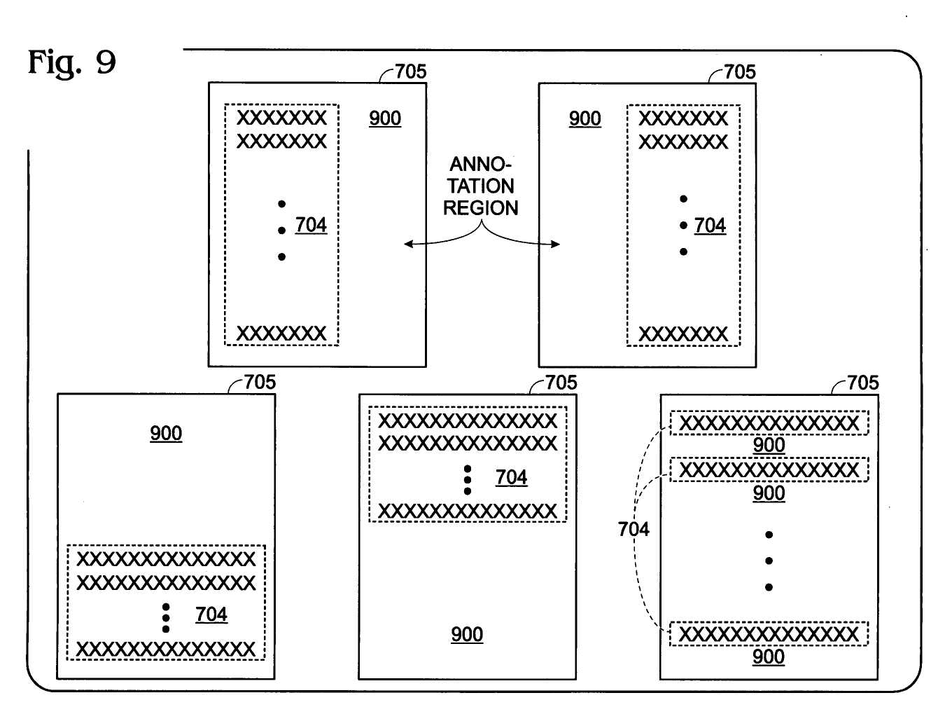

FIG. 9 is a diagram depicting a variety of annotation region options. The layout designer can be used to create the manual annotation regions 900 to the right of the page 704, left of the page 704, above the page 704, below the page 704, and between page image objects.

FIG. 10 is a first example of reformatting process that maintains the page proportional relationships. In this simple example, the document page 704 is simply compressed into the upper-left hand corner of the sheet 705. Here, the margins, font, line spacing, page height, and page width are all proportionally reduced. The area 900 to the right and below the page 704 can be used for annotations.

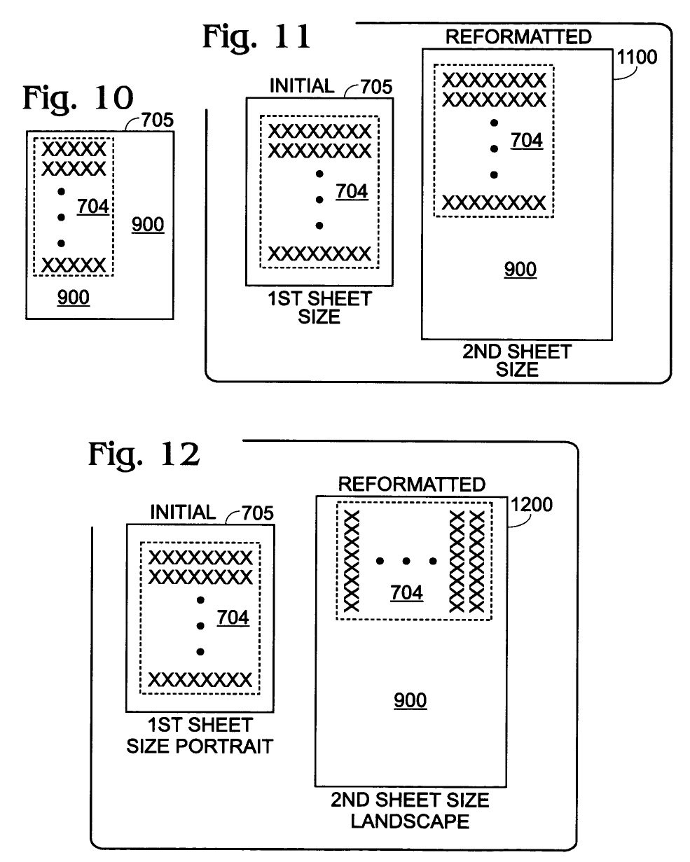

FIG. 11 is a second example of a reformatting process that maintains the page proportional relationships. Considering both FIGS. 7 and 11, the driver 700 accepts a document page 704 setup for printing on a first printed medium sheet size 705. In response to the layout designer UI 710 accept a sheet extension option, the relationship between the document page and the printed medium sheet is edited by changing from the first sheet size 705 to a second, larger sheet size 1100.

FIG. 12 is a third example of a reformatting process that maintains the page proportional relationships. Considering both FIGS. 7 and 12, the driver 700 accepts a document page 704 setup for printing on a first printed medium sheet size 705 in a portrait orientation. In response to the layout designer UI 710 accepting a rotated sheet extension option, the relationship between the document page 704 and the printed medium sheet 705 is edited by changing from the first sheet size 705 to a second, larger sheet size 1200. Further, the orientation is changed from portrait to landscape.

For example, the first printed medium sheet may be letter size (8.5×11-inch) and the second sheet may be ledger size (11×17-inch). Alternately, the first sheet size may be A4 and the second sheet size A3.

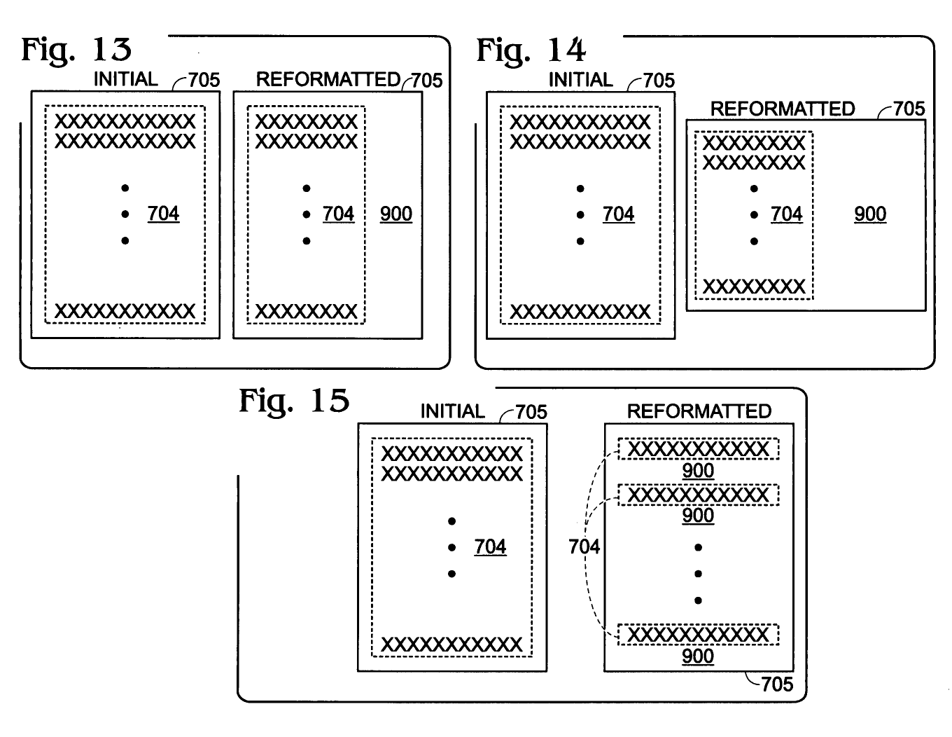

FIG. 13 is a first example of a reformatting process that rescales the document page. Considering FIGS. 7 and 13, the layout designer 708 can change the relationship between document page and sheet by resealing the document page in a non-proportional manner. For example, the relationship between margins, line spacing, and page length might be maintained, but the page width made smaller by decreasing the font size. Generally, the driver 700 accepts a document page 704 setup for printing on a first printed medium sheet size 705 in a first orientation. The layout designer UI 710 accepts a scaled option and edits the relationship between the document page and the printed medium sheet by maintaining the first printed medium sheet size 705 and orientation, while reducing size of the page 704. As noted above, the page size reduction can be made without maintaining the proportional relationship between the above-mentioned page elements. As shown, the vertical dimensions of the page 704 have been maintained, while the width has been reduced, in order to create the annotation region 900.

FIG. 14 is a second example of a reformatting process that rescales the document page. Considering FIGS. 7 and 14, the driver 700 accepts a document page 704 setup for printing on a first printed medium sheet size 705 in a portrait orientation. The layout designer UI 710 accepts a scaled 2UP option and edits the relationship between the document page and the printed medium sheet by maintaining the first printed medium sheet size 705, reducing the size of the page 704, and rotating the printed medium sheet 705 to a landscape orientation.

FIG. 15 is a third example of a reformatting process that rescales the document page. Considering FIGS. 7 and 15, the driver 700 accepts a document page 704 setup for printing on a first printed medium sheet size 705. The layout designer UI 710 accepts an alternate line annotation option and edits the relationship between the document page 704 and the printed medium sheet 705 by non-proportionally reducing the image object size with respect to the spacing between image objects. Using a text document as an example, the text font can be made smaller while maintaining the line spacing. Alternately, the layout designer 708 non-proportionally increases the spacing between image objects with respect to the image object size. Using the text document example, the line spacing between lines of text can be increased while the font size is maintained. As another alternative, the image object size can be decreased while the spacing between image objects is increased. Using any of these methods, the layout designer 708 creates manual annotation regions between the image objects.

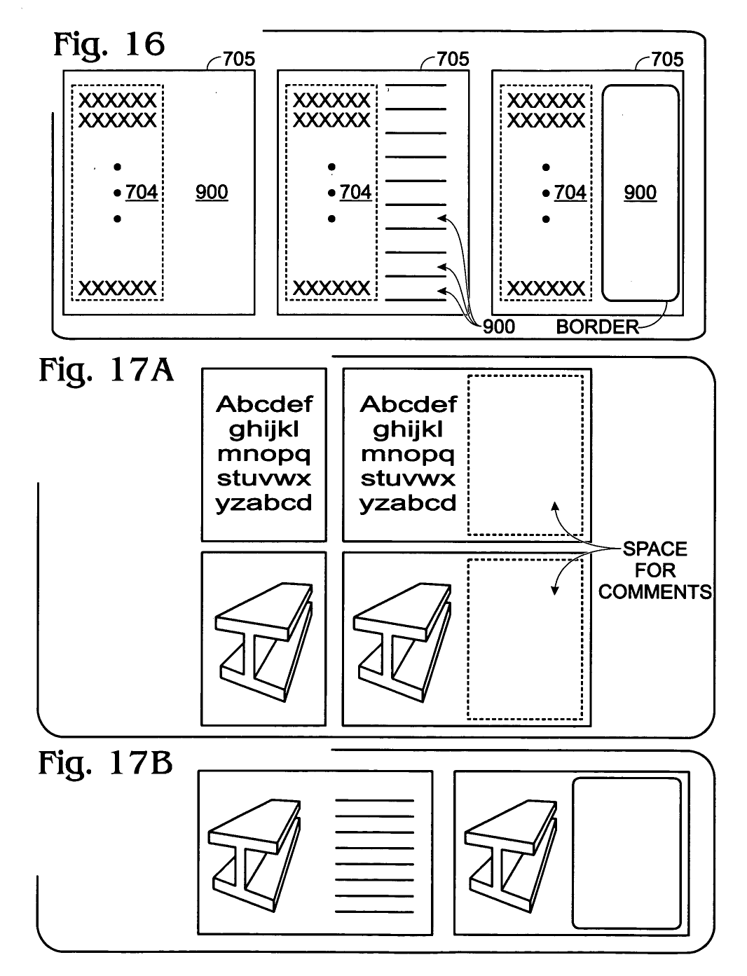

FIG. 16 is a drawing depicting annotation region formatting options. The layout designer UI may accept manual annotation region formatting options such as underlines, bordered, or blank (scratch pad). The underlines may help better organize a user's notes. The border may better identify the region designated for adding notes. Further, different border regions can be cross-referenced to different document sections.

### Functional Description

The present invention printer driver creates printing documents with a scratch pad area, which provides a means for a user to manually add comments to a document. Generally, the printer driver uses one of three approaches, or combinations of these approaches to create a manual annotation region. In addition to the conventional printing operations, the printer driver creates an area of free space in the document.

1. Printing on a Larger Sheet of Paper.

FIG. 17A is a diagram depicting a process that creates an annotation region by increasing the printed medium sheet size. For example, A3 paper has a width dimension that is two times the width of A4 paper. So in one aspect, the printer driver creates an annotation region by generating the rendered data with A4 paper dimensions, changing the orientation to landscape, and the paper size to A3. These operations create enough space on the right half of the sheet for making notes, without compressing or clipping the contents of the document page. Generally, a change is made to a larger paper size to fit the initial document page, while creating the provision for manual comments.

FIG. 17B is a drawing depicted the larger sheets sizes of FIG. 17A, with formatted annotation regions. For example, the annotation region can be formatted with underlines or a border as shown.

2. Printing Scaled Document Page in Wider Orientation

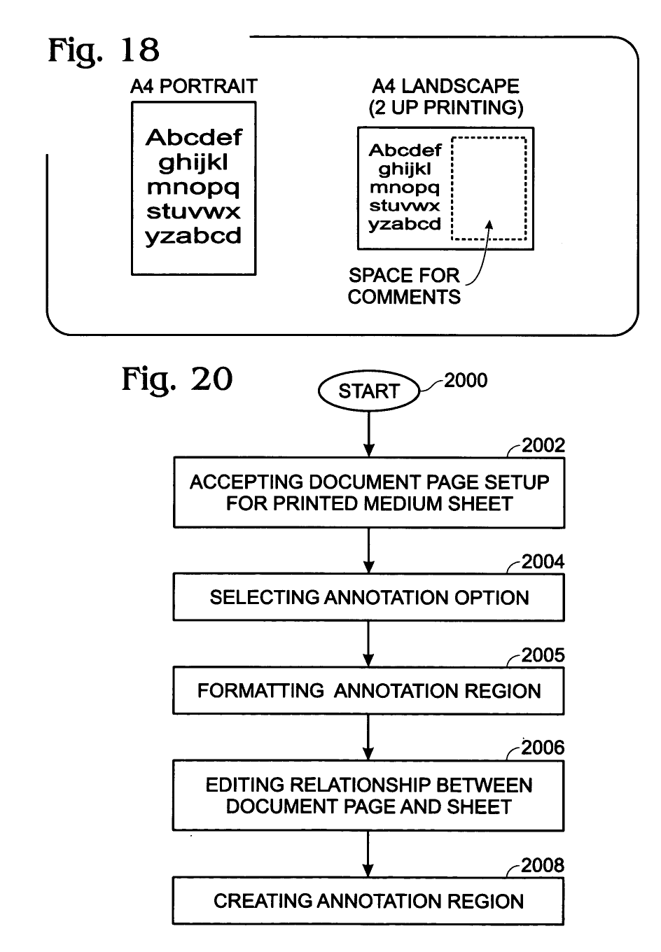

FIG. 18 is a drawing depicting a scaled 2UP annotation region formatting option. An annotation region can be achieved by printing every page in a variation of the conventional 2UP feature on the document's native page size. The document page can set to occupy the left half of the sheet and the right half can be used for taking notes and comments. Typically, the document page height is greater than the rotated sheet width. In this circumstance, the document page needs to be rescaled. For example, the font size and line spacing can be reduced.

3. Printing Document with Annotation Regions in the Line Spacings

Additional options presented in the printer driver UI may include printing without changing the sheet size or orientation. Instead, a smaller font size with double spacing, for example, may be used to create space between the lines for notes.

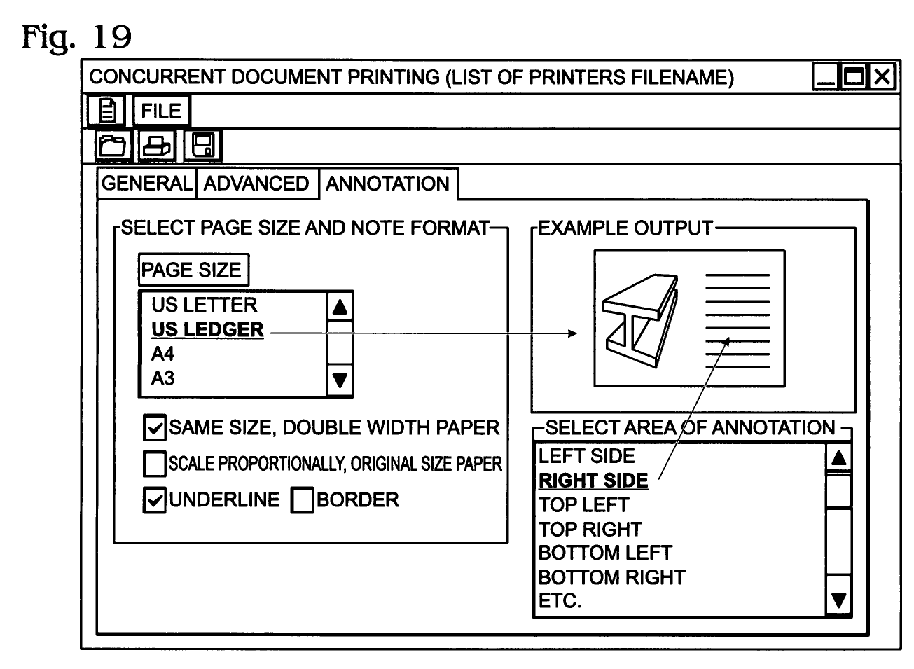

FIG. 19 is a depiction of an exemplary layout designer user interface. As shown, the user has the options of selecting paper size, scaling, and annotation region formatting.

FIG. 20 is a flowchart illustrating a method for reformatting a document for manual annotations in a printer driver software program. Although the method is depicted as a sequence of numbered steps for clarity, no order should be inferred from the numbering unless explicitly stated. It should be understood that some of these steps may be skipped, performed in parallel, or performed without the requirement of maintaining a strict order of sequence. The method starts at Step 2000.

Step 2002 accepts an electronically formatted document page setup for a printed medium sheet. Step 2004 selects a manual annotation option. Step 2006 edits the relationship between the document page and the printed medium sheet in response to the selected option. Step 2008 creates a manual annotation region on the sheet adjacent the document page. For example, Step 2008 may create the manual annotation region to the right of the page, left of the page, above the page, below the page, or between image objects.

Accepting the electronically formatted document page in Step 2002 includes accepting a page having a proportional relationship between image object size, page width, page height, margins, and spacing between image objects. In some aspects, editing the relationship between the document page and the printed medium sheet in Step 2006 includes maintaining the page proportional relationships.

For example, Step 2002 may accept a document page setup for printing on a first printed medium sheet size. In response to selecting a sheet extension manual annotation option in Step 2004, Step 2006 may change from the first sheet size to a second, larger sheet size.

In another example, Step 2002 may accept a document page setup for printing on a first printed medium sheet size in a portrait orientation. In response to selecting a rotated sheet extension manual annotation option in Step 2004, Step 2006 changes from the first sheet size to a second, larger sheet size, and changes the orientation from portrait to landscape. If the first sheet size is A4, the second sheet size could be A3. If the first sheet size is letter (8.5×11-inch), the second sheet size may be ledger (11×17-inch).

In a different aspect, Step 2002 may accept a document page setup for printing on a first printed medium sheet size in a first orientation. In response to selecting a scaled manual annotation option in Step 2004, Step 2006 maintains the first printed medium sheet size and orientation, and reduces the page size. The page size can be reduced proportionally, maintaining the proportional relationships between margin, font, spacing, page height, and page width. Alternately, the page can be reduced non-proportionally, by reducing the font and page width for example.

In another aspect, Step 2002 may accept a document page setup for printing on a first printed medium sheet size in a portrait orientation. In response to selecting a scaled 2UP manual annotation option in Step 2004, Step 2006 maintains the first printed medium sheet size, reduces the page size (proportionally or non-proportionally), and rotates the printed medium sheet to a landscape orientation.

In one other aspect, Step 2002 may accept a document page setup for printing on a first printed medium sheet size. In response to selecting an alternate line manual annotation option in Step 2004, Step 2006 either non-proportionally reduces the image object size with respect to the spacing between image objects, or non-proportionally increases the spacing between image objects with respect to the image object size. Then, creating the manual annotation region adjacent the document page in Step 2008 includes creating manual annotation regions between the image objects.

In one aspect, Step 2005 formats the manual annotation region in response to printer driver UI commands. The formatting options include underlines, borders, and blank (scratch pad). However, the method is not limited to any particular annotation region format.

A printer driver reformatting software program and a method for reformatting a document for manual annotations using a printer driver have been provided. Examples of particular layouts and application have been presented to illustrate the invention. However, the invention is not limited to merely these examples. Other embodiments and variations of the invention will occur to those skilled in the art.

We claim:

1. In a printer driver software program, a method for reformatting a document for manual annotations, the method comprising:
accepting an electronically formatted document page setup for a printed medium sheet;
selecting a manual annotation option;
in response to the selected option, editing the relationship between the document page and the printed medium sheet; and
creating a manual annotation region on the sheet adjacent the document page.

2. The method of claim 1 wherein accepting the electronically formatted document page includes accepting a page having a proportional relationship between image object size, page width, page height, margins, and spacing between page image objects; and,
wherein editing the relationship between the document page and the printed medium sheet includes maintaining the page proportional relationships.

3. The method of claim 1 wherein creating the manual annotation region adjacent the document page includes creating the manual annotation region adjacent to page in an area selected from the group including right of the page, left of the page, above the page, below the page, and between image objects.

4. The method of claim 1 wherein accepting the electronically formatted document page setup for the printed medium sheet includes accepting a document page setup for printing on a first printed medium sheet size;
wherein selecting the manual annotation options includes selecting a sheet extension option; and,
wherein editing the relationship between the document page and the printed medium sheet includes changing from the first sheet size to a second, larger sheet size.

5. The method of claim 1 wherein accepting the electronically formatted document page setup for the printing medium sheet includes accepting a document page setup for printing on a first printed medium sheet size in a portrait orientation;
wherein selecting the manual annotation options includes selecting a rotated sheet extension option; and,
wherein editing the relationship between the document page and the printed medium sheet includes:
changing from the first sheet size to a second, larger sheet size; and,
changing the orientation from portrait to landscape.

6. The method of claim 5 wherein accepting the electronically formatted document page setup for the printed medium sheet includes accepting a document page setup for printing on a first printed medium sheet selected from the group including letter (8.5×11-inch) and A4; and,
wherein editing the relationship between the document page and the printed medium sheet includes changing from a first sheet size of letter and A4, to ledger (11×17-inch) and A3, respectively.

7. The method of claim 1 wherein accepting the electronically formatted document page setup for the printed medium sheet includes accepting a document page setup for printing on a first printed medium sheet size in a first orientation;
wherein selecting the manual annotation options includes selecting a scaled option; and,
wherein editing the relationship between the document page and the printed medium sheet includes:
maintaining the first printed medium sheet size and orientation; and
reducing the page size.

8. The method of claim 1 wherein accepting the electronically formatted document page setup for the printed medium sheet includes accepting a document page setup for printing on a first printed medium sheet size in a portrait orientation;
wherein selecting the manual annotation options includes selecting a scaled 2UP option; and,
wherein editing the relationship between the document page and the printed medium sheet includes:
maintaining the first printed medium sheet size;
reducing the page size; and
rotating the printed medium sheet to a landscape orientation.

9. The method of claim 1 wherein accepting the electronically formatted document page setup for the printed medium sheet includes accepting a document page setup for printing on a first printed medium sheet size;
wherein selecting the manual annotation options includes selecting an alternate line annotation option; and,
wherein editing the relationship between the document page and the printed medium sheet includes:
non-proportionally reducing the image object size with respect to the spacing between image objects; and
non-proportionally increasing the spacing between image objects with respect to the image object size; and
wherein creating the manual annotation region adjacent the document page includes creating manual annotation regions between the image objects.

10. The method of claim 1 further comprising:
formatting the manual annotation region.

11. The method of claim 10 wherein formatting the manual annotation region includes choosing an option selected from the group including underlines, bordered, and blank.

12. A printer driver with manual annotation reformatting capabilities, the driver comprising:
an input to accept an electronically formatted document page from a client application, the document page setup for a printed medium sheet;
an layout designer having a user interface (UI) for accepting a manual annotation option, the layout designer accepting the document page and editing the relationship between the document page and the printed medium sheet, in response to the selected option, and creating a manual annotation region on the sheet adjacent the document page; and
a monitor to supply the document page with annotation region to a printer.

13. The driver of claim 12 wherein the printer driver accepts a document page having a proportional relationship between image object size, page width, page height, margins, and spacing between page image objects; and,
wherein the layout designer edits the relationship between the document page and the printed medium sheet, while maintaining the page proportional relationships.

14. The driver of claim 12 wherein the layout designer creates the manual annotation region adjacent to page in an area selected from the group including right of the page, left of the page, above the page, below the page, and between image objects.

15. The driver of claim 12 wherein the driver accepts a document page setup for printing on a first printed medium sheet size;
wherein the layout designer UI accepts a sheet extension option and edits the relationship between the document page and the printed medium sheet by changing from the first sheet size to a second, larger sheet size.

16. The driver of claim 12 wherein the driver accepts a document page setup for printing on a first printed medium sheet size in a portrait orientation;
wherein the layout designer UI accepts a rotated sheet extension option and edits the relationship between the document page and the printed medium sheet by:
changing from the first sheet size to a second, larger sheet size; and
changing the orientation from portrait to landscape.

17. The driver of claim 16 wherein the driver accepts a document page setup for printing on a first printed medium sheet selected from the group including letter (8.5×11-inch) and A4; and
wherein the layout designer edits the relationship between the document page and the printed medium sheet by changing from a first sheet size of letter and A4, to ledger (11×17-inch) and A3, respectively.

18. The driver of claim 12 wherein the driver accepts a document page setup for printing on a first printed medium sheet size in a first orientation;
wherein the layout designer UI accepts a scaled option and edits the relationship between the document page and the printed medium sheet by:
maintaining the first printed medium sheet size and orientation; and
reducing the page size.

19. The driver of claim 12 wherein the driver accepts a document page setup for printing on a first printed medium sheet size in a portrait orientation;
wherein the layout designer UI accepts a scaled 2UP option and edits the relationship between the document page and the printed medium sheet by:
maintaining the first printed medium sheet size;
reducing the page size; and
rotating the printed medium sheet to a landscape orientation.

20. The driver of claim 12 wherein the driver accepts a document page setup for printing on a first printed medium sheet size;
wherein the layout designer UI accepts an alternate line annotation option and edits the relationship between the document page and the printed medium sheet by:
non-proportionally reducing the image object size with respect to the spacing between image objects; and
non-proportionally increasing the spacing between image objects with respect to the image object size; and
wherein the layout designer creates manual annotation regions between the image objects.

21. The driver of claim 12 wherein the layout designer UI accepts manual annotation region formatting options selected from the group including underlines, bordered, and blank.
